(19) United States
(12) Patent Application Publication
(10) Pub. No.: US 2025/0235053 A1
(43) Pub. Date: Jul. 24, 2025

(54) MODULAR CULINARY EQUIPMENT STORAGE SYSTEM

(71) Applicant: Caraway Home, Inc., New York, NY (US)

(72) Inventors: Jordan Nathan, New York, NY (US); Dickon Isaacs, Los Altos, CA (US); Sehee Ahn, San Francisco, CA (US); Bret Recor, Princeville, HI (US)

(73) Assignee: Caraway Home, Inc., New York, NY (US)

(21) Appl. No.: 18/963,349

(22) Filed: Nov. 27, 2024

Related U.S. Application Data
(60) Provisional application No. 63/623,766, filed on Jan. 22, 2024.

(51) Int. Cl. A47J 47/16

(52) U.S. Cl. CPC A47J 47/16

(57) ABSTRACT

A culinary equipment storage system comprising: a modular storage apparatus comprising: a bottom surface; a front end disposed orthogonally to a first side of the bottom surface, the front end having a front end width; a back end disposed orthogonally to a second side of the bottom surface, the back end having a back end width; a plurality of dividers disposed orthogonally to the bottom surface between the front end and the back end, the plurality of dividers having a divider width; and a plurality of storage slots disposed between the front end, the plurality of dividers, and the back end, and the front end, back end, and the plurality of dividers extending vertically from the bottom surface, wherein the front end, back end, and the plurality of dividers exist in a parallel plane.

### CROSS REFERENCE TO RELATED APPLICATIONS

The present application claims the benefit of U.S. Patent Application No. 63/623,766 for MODULAR CULINARY EQUIPMENT STORAGE SYSTEM, filed Jan. 22, 2024, the entire contents of which are incorporated herein by reference.

### FIELD OF THE DISCLOSURE

The present disclosure is directed to a modular culinary equipment storage system. More specifically, the present disclosure is directed to a modular culinary equipment storage system facilitating economical utilization of space and improved storage capabilities for culinary equipment.

### INTRODUCTION

Modern kitchens are equipped with a wide array of pans, pots, and storage receptacles that are essential for preparing various dishes. Typically, a lid accompanies all the aforementioned cooking implements to seal them for efficient cooking or storage. Given the diverse range of equipment and their crucial role in cooking, as well as the lids accompanying said equipment, ensuring easy accessibility becomes paramount.

The continuous use of cooking implements in daily life, coupled with the varying layouts of kitchens in different homes, has inspired the innovation of various storage solutions for these cooking tools. However, the challenge lies in creating systems that not only enhance accessibility but also accommodate the limited space in kitchens.

Traditional kitchen storage systems aim to optimize accessibility while minimizing required space. In scenarios where kitchen space is at a premium, as is often the case in urban apartments, efficient use of that space is highly desirable. However, conventional storage systems, typically comprising drawers or cabinets where cooking paraphernalia are randomly stored, has proven to be an inefficient utilization of kitchen space. The mismatched shapes of various implements and their lids prevents users from maximizing efficient storage of their cooking implements, as well as increasing the time required to search for specific tools during the cooking process. In essence, traditional storage methods force cooks to compromise kitchen organization at the expense of efficiency.

Therefore, there is a need for systems and apparatus optimizing both space and efficiency in the kitchen. Additionally, providing cooks with the flexibility to customize storage arrangements according to their needs would be highly desirable.

Introducing modular, customizable, efficient, and space-conscious systems and devices for storing cooking implements proves advantageous over traditional storage methods. It would be desirable to provide systems capable of being adapted to various kitchen sizes and countertop configurations, offering a practical and efficient storage solution for cooks.

Hence, the provided systems and apparatus, incorporating these advantageous features, present an innovative solution to enhance the cooking experience.

### SUMMARY

This Summary is provided to introduce a selection of concepts in a simplified form that are further described below in the Detailed Description. This Summary is not intended to identify key features or essential features, nor is it intended to limit the scope of the claims included herewith.

Aspects of the present disclosure relate to a culinary equipment storage system. The culinary equipment storage system comprised of a modular storage apparatus comprising: a bottom surface; a front end disposed orthogonally to a first side of the bottom surface, the front end having a front end width; a back end disposed orthogonally to a second side of the bottom surface, the back end having a back end width; a plurality of dividers disposed orthogonally to the bottom surface between the front end and the back end, the plurality of dividers having a divider width; and a plurality of storage slots disposed between the front end, the plurality of dividers, and the back end, and the front end, back end, and the plurality of dividers extending vertically from the bottom surface, wherein the front end, back end, and the plurality of dividers exist in a parallel plane.

In an embodiment, the back end width is equal to the divider width, and wherein the back end width and the divider width are greater than the front end width.

In another embodiment, the plurality of dividers are comprised of a first divider, a second divider, and a third divider. Moreover, the plurality of storage slots are comprised of: a first storage slot between the back end and the first divider, a second storage slot between the first divider and the second divider, a third storage slot between the second divider and the third divider, and a fourth storage slot between the third divider and the front end. Additionally, the modular storage apparatus further comprises: a plurality of magnets disposed within at least one of the: front end, back end, first divider, second divider, and third divider.

In a further embodiment, the culinary equipment storage system is further comprised of one or more lids comprising: a small lid; a first intermediate lid; a second intermediate lid; and a large lid. Furthermore, the plurality of magnets reversibly adhere to the one or more lids. Yet further, the small lid is housed by the fourth storage slot, the first intermediate lid housed by the third storage slot, the second intermediate lid is housed by the second storage slot, and the large lid is housed by the first storage slot.

In yet a further embodiment, the one or more lids further comprise: a small handle disposed atop the small lid; a first intermediate handle disposed atop the first intermediate lid; a second intermediate handle disposed atop the second intermediate lid; and a large handle disposed atop the large lid. Moreover, the plurality of magnets are disposed within a top surface of at least one of the back end, the first divider, the second divider, and the third divider. Lastly, the small handle, first intermediate handle, second intermediate handle, and large handle reversibly adhere to the plurality of magnets disposed within the top surface of the front end, third divider, second divider, and first divider, respectively.

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 illustrates an embodiment of a top front right perspective view of a modular culinary equipment storage system;

FIG. 2 illustrates an embodiment of a left side view of the storage system;

FIG. 3 illustrates an embodiment of a right side view of the storage system;

FIG. 4 illustrates an embodiment of a top view of the storage system;

FIG. 5 illustrates an embodiment of a bottom view of the storage system;

FIG. 6 illustrates an embodiment of the storage system housing one or more lids;

FIG. 7 illustrates an embodiment of the storage system housing the one or more lids;

FIG. 8 illustrates an embodiment of the storage system housing the one or more lids; and

FIG. 9 illustrates an embodiment of the storage system housing the one or more lids.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

It is noted that description herein is not intended as an extensive overview, and as such, concepts may be simplified in the interests of clarity and brevity.

All documents mentioned in this application are hereby incorporated by reference in their entirety. Any process described in this application may be performed in any order and may omit any of the steps in the process. Processes may also be combined with other processes or steps of other processes.

Disclosed herein are apparatuses and systems for culinary equipment storage. In an embodiment, the system provides a space-saving benefit. In another embodiment, the system provides a customizable solution for storing various culinary implements, wherein said implements may include lids for one or more pots, pans, and the like. Further disclosed is a novel apparatus and system configured to avoid haphazard storage of culinary implements. Thus, improving the efficiency of culinary implement storage, by reducing the requisite time to find said implements in less efficient storage systems. Additionally, such a system may increase the aesthetic appearance of a kitchen.

In an embodiment, the present disclosure is a modular culinary equipment storage system (the “storage system”) 100. The storage system 100 may be configured to store one or more lids for a cook's culinary implements without the need for indiscriminate placement of said lids in a cabinet.

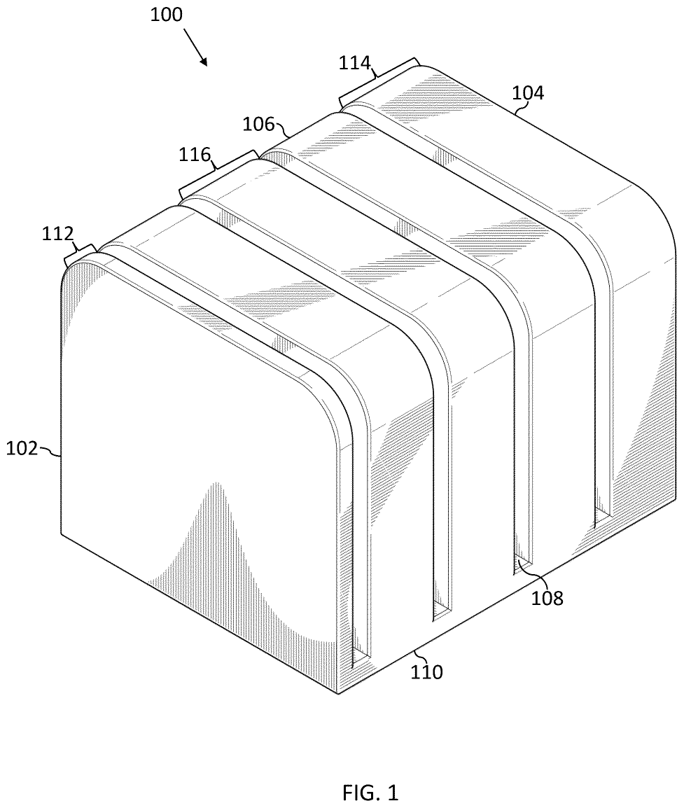

Referring to FIG. 1, the storage system 100 comprises a plurality of components. In an embodiment, the plurality of components may include a front end 102, a back end 104, a plurality of dividers 106, and/or a plurality of storage slots 108. In an embodiment, the plurality of storage slots 108 may be disposed between the front end 102 and the back end 104. As a nonlimiting example, each of the plurality of storage slots 108 may be defined by a space between each of the front end 102, the back end 104, and/or the plurality of dividers 106. Additionally, the front end 102, back end 104, and the plurality of dividers 106 may have a corresponding front end width 112, back end width 114, and divider width 116.

The storage system 100 may be composed of a storage system material, wherein said material may include at least one of ceramic, glass, metal, plastic, wood, medium-density fiber (“MDF”), rubber, stone, granite, concrete, and/or composites (e.g., carbon fiber). In an embodiment, the storage system 100 may be composed of one or more of the aforementioned storage system materials. In another embodiment, the storage system 100 may be composed of aluminum or steel (e.g., the aluminum may be powder coated in color) with a silicone foot, wherein said foot is disposed upon a bottom surface 110 of the storage system 100 (described in more detail below). In a further embodiment, the storage system 100 may be composed of wood with the silicone foot. In an alternative embodiment, the storage system 100 may be composed of stainless steel (or any other type of metal), MDF with a fabric covering, plastic, silicone, thermoplastic rubber (“TPF”), glass, and/or stone. However, the storage system 100 may be composed of any suitable combination of materials.

Additionally, the storage system 100 may include a colored powder coating and/or a lacquer natural varnish on an exterior surface of the storage system 100. In various embodiments, based on the storage system material, the storage system 100 may include any surface finish, coating, color, and/or texture to change the aesthetic or performance of said system 100. The storage system 100 may be sized for utilization in standard cabinets. However, the storage system 100 may be sized to fit a variety of cabinets, counter tops, and/or pantries.

In an embodiment, the storage system 100 or components of the system 100 may include a covering. The covering may be utilized to prevent one or more lids (described in more detail below) from slipping out of and/or scratching adjacent lids. As a nonlimiting example, MDF may be used to construct the storage system 100, wherein the rigidity of the MDF is configured to seamlessly accept the covering. In yet a further embodiment, the storage system 100 may be comprised of a non-slip bottom. In such an embodiment, the non-slip bottom may prevent the system 100 from slipping while atop a supporting surface. In an alternative embodiment, the non-slip bottom may be disposed upon the bottom surface 110.

Additionally, the covering may be waterproof (for example, to promote integrity of the storage system 100 when wet items are deposited within or adjacent to the system 100). Moreover, the covering may be textured (for example, to promote friction such the one or more lids do not move excessively when deposited within the storage system 100). The covering may be at least one of 720 D cotton/linen fabric, 1 MM, waterproof, and 200-210 gsm. In another embodiment, the covering may accommodate a weave pattern for texture. However, the covering may be comprised of any suitable textile alternative. In one embodiment, the covering may be treated with a spray finish, for example, a clear coat finish. Such a spray finish may increase the integrity of the storage system 100 both structurally and aesthetically (for example, preventing stains or providing a surface that is easier to clean).

In various embodiments, the storage system 100 may include any suitable number and/or configuration of dividers 106 and/or storage slots 108. For example, the plurality of storage slots 108 may include seven (7) individual slots defined by the front end 102, the back end 104, and six (6) individual dividers. In an exemplary embodiment, the storage system 100 may be comprised of four (4) storage slots defined by the front end 102, the back end 104, and three (3) individual dividers. In such an embodiment, the plurality of dividers 106 may be comprised of a first divider 702, a second divider 704, and a third divider 706. In a further embodiment, the plurality of storage slots 108 may be disposed between at least one of the back end 104, first divider 702, second divider 704, third divider 706, and front end 102. For instance, the plurality of storage slots 108 may be comprised of a first storage slot 708 between the back end 104 and the first divider 702, a second storage slot 710 between the first divider 702 and the second divider 704, a third storage slot 712 between the second divider 704 and the third divider 706, and a fourth storage slot 714 between the third divider 706 and the front end 102.

In an embodiment, the plurality of dividers 106, may be comprised of a first quantity of dividers, wherein said first quantity of dividers are of a first width. For instance, the first width, may be the divider width 116. In such an embodiment, the plurality of dividers 106 may be further comprised of a second quantity of dividers, wherein said second quantity of dividers are of a second width. Furthermore, a top surface of the front end 102, the back end 104, and the plurality of dividers 106 may be adapted to hold the handle of a lid, such that the front end 102, the back end 104, and the plurality of dividers 106 may be sized according to the dimensions of the handles of a given lid set (described in more detail below). Further, each of the plurality of storage slots 108 may be of uniform dimensions and the top surfaces of the front end 102, the back end 104, and/or the plurality of dividers 106 may provide support such that lids of various dimensions may be situated within the storage slots 108 having the same dimensions. In such an example, the support for the handles offered by the front end 102, the back end 104, and/or the plurality of dividers 106 allows any lid size to be deposited within any dimension of the plurality of storage slots 108.

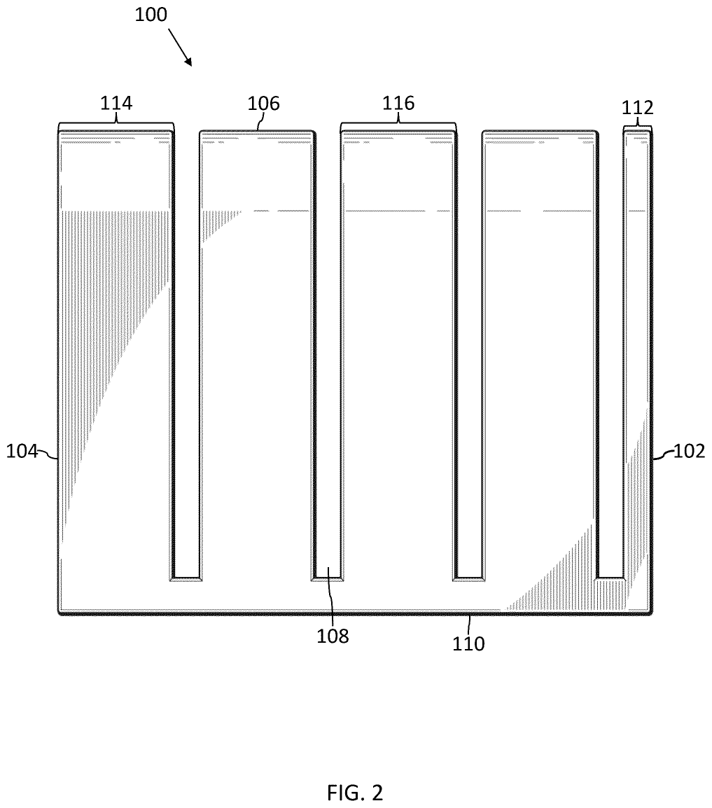

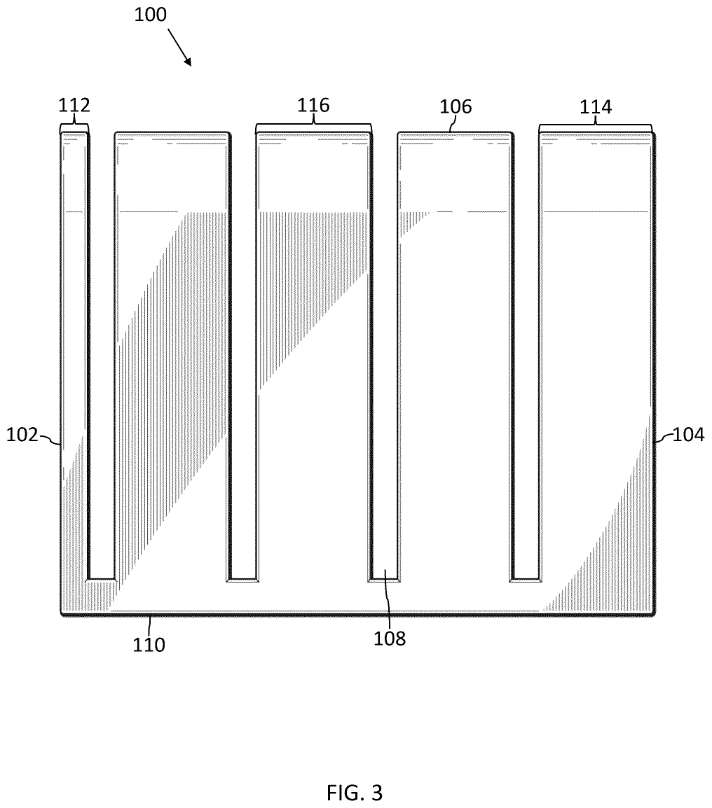

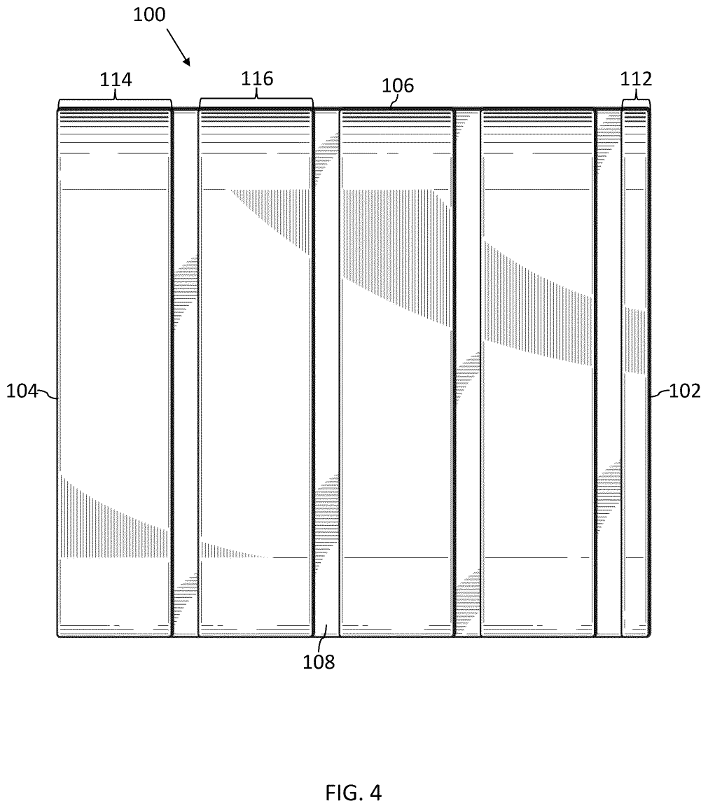

Referring to FIGS. 2-4, the front end 102 may be configured into a front end shape, wherein the shape is at least one of a rectangle, a square, a half ellipse, a half circle, a trapezoid, and half of a chamfered rectangle. However, the front end shape may be comprised of any suitable shape alternative. Further, the front end 102 may have a front end depth defined by a first front end side and a second front end side. In an embodiment, the first front end side may be exposed to an exterior environment and the second front end side may be exposed to an interior environment (i.e., one of the plurality of storage slots 108), or vice versa.

The back end 104 may be configured into a back end shape, wherein the shape is at least one of a rectangle, a square, a half ellipse, a half circle, a trapezoid, and half of a chamfered rectangle. However, the back end shape may be comprised of any suitable shape alternative. Further, the back end 104 may have a back end depth defined by a first back end side and a second back end side. In an embodiment, the first back end side may be exposed to the exterior environment and the second back end side may be exposed to the interior environment (i.e., one of the plurality of storage slots 108), or vice versa.

The plurality of dividers 106 may be configured into a divider shape, wherein the shape is at least one of a rectangle, a square, a half ellipse, a half circle, a trapezoid, and half of a chamfered rectangle. However, the divider shape may be comprised of any suitable shape alternative. Further, the divider width 116 may be defined by a first divider side and a second divider side. In an embodiment, the first divider side and the second divider side may be exposed to the interior environment (i.e., one or more of the plurality of storage slots 108).

In an embodiment, the divider width 116 may be less than the back end width 114, or vice versa. As a nonlimiting example, the front end width 112 may be less than the back end width 114, such that the front end 102 may abut a wall. In such a nonlimiting example, the front end 102 may sit flush against the wall. In an embodiment, the difference in front end width 112 and back end width 114, may enable a user to retrieve and/or deposit a lid from one of the plurality of storage slots 108 without being obstructed by another lid occupying a different storage slot comprising the plurality of storage slots 108. In another embodiment, the divider width 116 is equal to at least one of the front end width 112 and the back end width 114. In an alternative embodiment, the divider width 116 is not equal to the front end width 112 and/or the back end width 114.

The front end 102, the back end 104, and/or the plurality of dividers 106 may include a rounded bevel. For example, a top edge of the first front end side, the second front end side, the first back end side, the second back end side, the first divider side, and/or the second divider side of the front end 102, the back end 104, and the plurality of dividers 106 may be rounded to enable unobstructed placement and withdrawal of one or more lids within the storage system 100. Accordingly, said rounded edges may be less jagged and, thus, less likely to cause snags (as opposed to a sharp ninety-degree corner) when depositing the one or more lids within the storage system 100. Accordingly, the rounded edges increase the safety of the system 100 by decreasing a user injury probability via a user bumping into the storage system 100.

The plurality of storage slots 108 may be defined by a space created between at least one of the first front end side, the second front end side, the first back end side, the second back end side, the first divider side, and the second divider side. As a nonlimiting example, one of the plurality of storage slots 108 may be defined by the second front end side and the first divider side. Additionally, the plurality of storage slots 108 may exist in a plane parallel to the front end 102, the back end 104, and/or the plurality of dividers 106.

The plurality of storage slots 108 may be configured to receive and/or house the one or more lids. In an embodiment, the one or more lids may include a lid for a pot and/or a lid for a pan. The one or more lids may further include a lid for a food storage receptacle (e.g., the lid for a plastic container). In another embodiment, the plurality of storage slots 108 may be configured to house a portion of one of the one or more lids, such that said lid is partially housed by the storage system 100 and is partially exposed to the exterior environment.

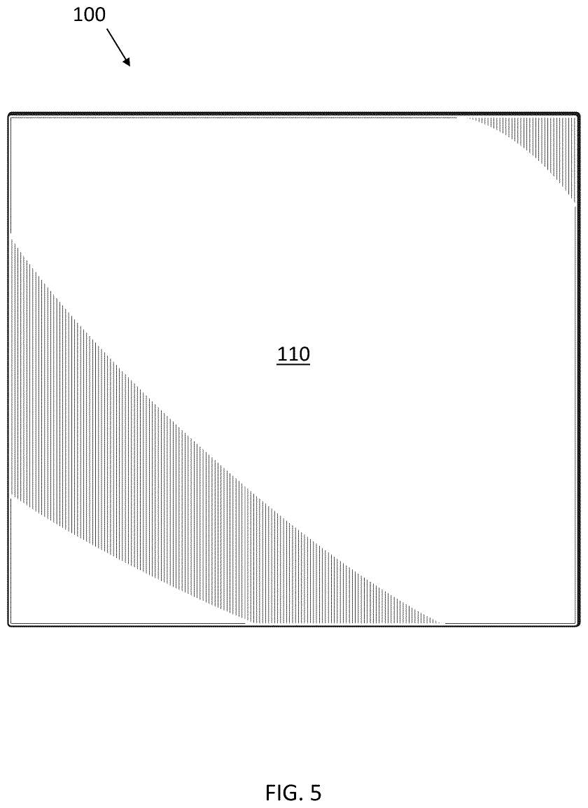

Referring to FIG. 5, the storage system 100 may be further comprised of the bottom surface 110. In an embodiment, at least one of the front end 102, the back end 104, and the plurality of dividers 106 may be orthogonal to the bottom surface 110. In an alternative embodiment, the front end 102, the back end 104, and the plurality of dividers 106 may not be orthogonal to the bottom surface.

In an embodiment, the bottom surface 110 may employ a plurality of magnets 610 (e.g., N52 magnets) and/or ferrous material, such that said surface 110 is able to reversibly adhere to external surfaces. In another embodiment, the bottom surface 110 may include a carbon steel sheet on the underside (e.g., underneath the silicone foot), for example, to enable the bottom surface 110 to magnetically adhere to external surfaces. In another embodiment, the bottom surface 110 may be reversibly affixed to external surfaces with any suitable fastening mechanisms, including, but not limited to, hook-and-loop fasteners.

The storage system 100 itself may include the plurality of magnets 610. In an embodiment, the plurality of magnets 610 may be disposed within at least one of the front end 102, the back end 104, and the plurality of dividers 106. In another embodiment, the plurality of magnets 610 may be disposed upon the first front end side, the second front end side, the first back end side, the second back end side, the first divider side, and/or the second divider side.

The plurality of magnets 610 may be configured to reversibly adhere to external surfaces. In an embodiment, the plurality of magnets 610 may be configured to adhere to at least one of the one or more lids, such that said lids are discouraged from inadvertent movement. As a nonlimiting example, one of the one or more lids, housed by one of the plurality of storage slots 108, may be discouraged from inadvertent movement. In such a nonlimiting example, movement may be discouraged if a user bumps into the storage system 100 but may not be discouraged from movement if the user desires to remove one of the one or more lids from the storage system 100.

In an embodiment, the plurality of magnets 610 may enable a first storage system to reversibly couple to the second storage system. In such an embodiment, the user may be able to increase the plurality of storage slots 108 via the reverse coupling of the first storage system to the second storage system. For instance, the plurality of magnets 610 may be disposed within the front end 102 and/or back end 104 of the first storage system, such that said magnets 610 may reversibly adhere to the plurality of magnets 610 disposed within the front end 102 and/or back end 104 of the second storage system. In such an example, the front end 102 and/or back end 104 of the first storage system may interface with the front end 102 and/or back end 104 of the second storage system, effectively increasing the number of available storage slots 108. In yet another embodiment, the user may reversibly couple any number of storage systems to one another to increase the plurality of storage slots 108. As a nonlimiting example, the plurality of magnets 610 may include two magnets disposed in at least one of the front end 102 and the back end 104. In another example, the plurality of magnets 610 may include four magnets disposed in at least one of the front end 102 and the back end 104. However, the plurality of magnets 610 may include any number of magnets.

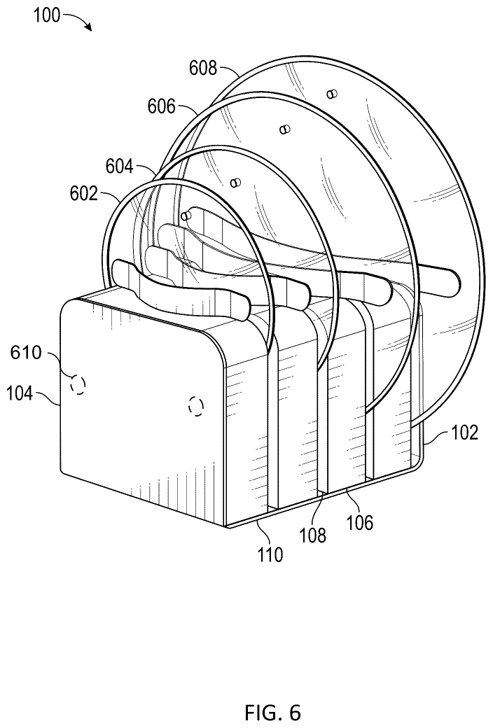

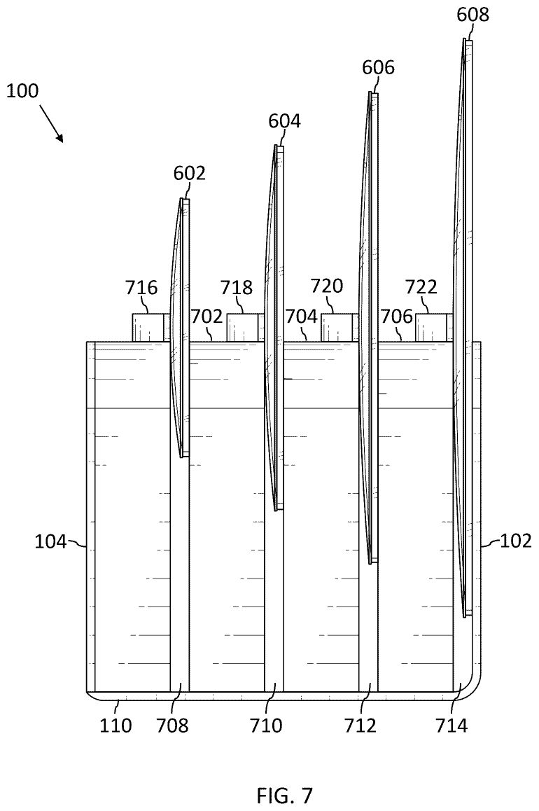

Referring to FIGS. 6 and 7, in an embodiment, the plurality of storage slots 108 may be further comprised of at least one storage slot opening, wherein said opening is defined by the space between the top edge of at least one of the front end 102, the back end 104, and the plurality of dividers 106. The storage slot opening may be in fluid communication with one of the plurality of storage slots 108 and/or the exterior environment, such that water and/or other debris may enter said opening and exit one of the plurality of storage slots 108 into the exterior environment. Accordingly, the plurality of storage slots 108 may prevent mold or other buildup within the storage system 100. In a further embodiment, the plurality of storage slots 108 may function as a drying rack.

As a nonlimiting example, the user may traverse the storage slot opening with a portion of at least one of the one or more lids. In such a nonlimiting example, the user may deposit at least one of said lids into one of the plurality of storage slots 108, such that said storage slot may house the lid.

In an embodiment, the top surface of at least one of the front end 102, the back end 104, and the plurality of dividers 106 may be configured to support a handle of one of the one or more lids. In such an embodiment, the handle may prevent the entirety of the lid from being housed by said storage slot. As a nonlimiting example, the user may deposit one of the one or more lids into one of the plurality of storage slots 108. While depositing said lid, the handle may enable a first portion of the lid to be housed by said storage slot, wherein the handle and a second portion of the lid may be exposed to the external environment. The depth of each of the plurality of storage slots 108 may be adapted for the diameter of a given lid and, similarly, the width of each handle-supporting surface (e.g., the top surface of the front end 102, the back end 104, and/or the plurality of dividers 106) may be adapted for the height/dimensions of a given lid handle. Thus, the depth of each of the storage slots 108, the divider width 116, and/or the dimensions of the lids may be correlated such that the storage system 100 is configured to securely house each of the lids in a set.

The one or more lids may be housed within the plurality of storage slots 108 in an upright position. In such an embodiment, the upright arrangement of the one or more lids may more efficiently utilize vertical space in a cabinet, while imposing a smaller horizontal footprint.

Additionally, the storage system 100 may be further comprised of the one or more lids and/or corresponding lid handles. In an embodiment, the one or more lids may include at least one of a small lid 602, a first 604 and second 606 intermediate lid, and a large lid 608.

Each of the one or more lids may include a corresponding handle. For example, the small 602, first 604 and second 606 intermediate, and large 606 lids may include a small 716, first 718 and second 720 intermediate, and large 722 handles respectively. The one or more corresponding handles may have a length proportional to a diameter of the corresponding one or more lids. For example, the small lid 602, first intermediate lid 604, and second intermediate lid 606, and their corresponding handles 716, 718, and 720, respectively, may have a diameter and length, that is less than those of the large lid 608 and its corresponding large handle 722. In another example, the first intermediate lid 604 and its corresponding handle 718, may have a diameter and length, respectively, smaller than those of the second intermediate lid 606 and its corresponding handle 720, or vice versa. However, the first intermediate lid 604 and/or the second intermediate lid 606 and their corresponding handles 718 and 720, may have a diameter and length, respectively, larger than the small lid 602 and its corresponding handle 716. As a nonlimiting example, the varying diameters of the one or more lids may correspond to varying diameters of a corresponding pot, pan, etc.

In another embodiment, the one or more corresponding handles may be configured to rest upon the top surface of the front end 102, the back end 104, and/or the plurality of dividers 106. In such an embodiment, a portion of the one or more lids may be configured to rest within the plurality of storage slots 108. As a nonlimiting example, a first portion of the one or more lids may be housed by one or the plurality of storage slots 108, and a second portion of the one or more lids, along with their corresponding handles, may be exposed to the external environment.

Moreover, the plurality of magnets 610 may be disposed upon the top surface of at least one of the front end 102, the back end 104, and the plurality of dividers 106. In an embodiment, the one or more corresponding handles may be configured to reversibly adhere to the top surface of the front end 102, the back end 104, and/or the plurality of dividers 106 via magnetic communication with the plurality of magnets 610. For example, the one or more corresponding handles may be comprised of a metal configured to reversibly adhere to the plurality of magnets 610 via magnetic communication. In an embodiment, the magnetic communication between the one or more corresponding handles and the plurality of magnets 610 may discourage inadvertent movement of the one or more lids.

In a further embodiment, a depth of each of the plurality of storage slots 108 may be adapted for the diameter of the one or more lids, similarly, the width of each handle-supporting surface (e.g., the top surface of at least one of the front end 102, the back end 104, and the plurality of dividers 106) may be adapted for the length of the corresponding handles.

In yet a further embodiment, the plurality of magnets 610 may be disposed within each of the plurality of dividers 106, such that upon placement of the one or more lids into the plurality of storage slots 108, said magnets 610 are configured to reversibly adhere to the one or more lids via magnetic communication. For example, the plurality of magnets 610 may reversibly adhere to a metal rim disposed upon the one or more lids via magnetic communication. As a further example, the magnetic communication between the plurality of magnets 610 and the one or more lids may discourage said lids from being dislodged from the plurality of storage slots 108 inadvertently. However, the magnetic communication between said magnets 610 and lids may facilitate removal of the one or more lids from the plurality of storage slots 108 via intentional user actuation of said lids.

As described above, the depth of each of the plurality of storage slots 108 may be adapted for the diameters of the one or more lids. In an embodiment, the depth of every storage slot comprising the plurality of storage slots 108 may be of a uniform depth. Meaning, the one or more lids may occupy varying depths of the plurality of storage slots 108 dependent upon the diameter of said lids. As a nonlimiting example, the plurality of magnets 610 may be disposed within the front end 102, back end 104, and plurality of dividers 106, defining the plurality of storage slots 108. In such an embodiment, the plurality of magnets 610 may be disposed at varying depths, such that said magnets 610 are able to reversibly adhere to the one or more lids of varying diameters, to ensure said magnets 610 and lids are in magnetic communication. In another nonlimiting example, the plurality of magnets 610 may be uniformly spaced throughout the depth of the plurality of storage slots 108, such that each of the plurality of storage slots can house one of the small lid 602, the first intermediate lid 604, the second intermediate lid 606, and the large lid 608 comprising the one or more lids.

In an exemplary embodiment, the first 708, second 710, third 712, and fourth 714 storage slots may be configured to house the large lid 608, second intermediate lid 606, first intermediate lid 604, and small lid 602, respectively.

As mentioned above, the plurality of dividers 106 may be further comprised of a first divider 702, a second divider 704, and a third divider 706. In an embodiment, the plurality of storage slots 108 may be disposed between at least one of the back end 104, first divider 702, second divider 704, third divider 706, and front end 102. For instance, the plurality of storage slots 108 may be comprised of a first storage slot 708 between the back end 104 and the first divider 702, a second storage slot 710 between the first divider 702 and the second divider 704, a third storage slot 712 between the second divider 704 and the third divider 706, and a fourth storage slot 714 between the third divider 706 and the front end 102.

Furthermore, the plurality of magnets 610 may be disposed within at least one of the front end 102, the back end 104, the first divider 702, the second divider 704, and the third divider 706. For instance, the plurality of magnets 610 may disposed within a top surface of at least one of the front end 102, the back end 104, the first divider 702, the second divider 704, and the third divider 706.

Furthermore, the storage system 100 is further comprised of one or more lids comprising the small lid 602, the first intermediate lid 604, the second intermediate lid 606, and the large lid 608. In an embodiment, the small lid 602 may be housed by the first storage slot 708, the first intermediate lid 604 may be housed by the second storage slot 710, the second intermediate lid 606 may be housed by the third storage slot 712, and the large lid 608 may be housed by the fourth storage slot 714. However, any one of the one or more lids may be housed within any one of the first storage slot 708, second storage slot 710, third storage slot 712, and fourth storage slot 714. In another embodiment, the plurality of magnets 610 may reversibly adhere to the one or more lids.

In a further embodiment, the one or more lids may be comprised of one or more corresponding handles. To illustrate, a small handle 716 may be disposed atop the small lid 602, a first intermediate handle 718 may be disposed atop the first intermediate lid 604, a second intermediate handle 720 may be disposed atop the second intermediate lid 606, and a large handle 722 may be disposed atop the large lid 608. As a nonlimiting example, the small handle 716, the first intermediate handle 718, the second intermediate handle 720, and the large handle 722 may reversibly adhere to the plurality of magnets 610 disposed within the top surface of at least one of the front end 102, the back end 104, the first divider 702, the second divider 704, and the third divider 706.

In yet a further embodiment, the front end 102, the back end 104, and the plurality of dividers 106 may have the front end width 112, the back end width 114, and the divider width 116, respectively. For example, the back end width 114 may be equal to the divider width 116, and the back end width 114 and the divider width 116 may each be greater than the front end width 112. Moreover, the front end 102, the back end 104, and the plurality of dividers 106 may extend vertically from the bottom surface 110. To illustrate, the front end 102, the back end 104, and the plurality of dividers 106 may be parallel to one another. Additionally, at least one of the front end 102, the back end 104, and the plurality of dividers 106 may be orthogonal to the bottom surface 110.

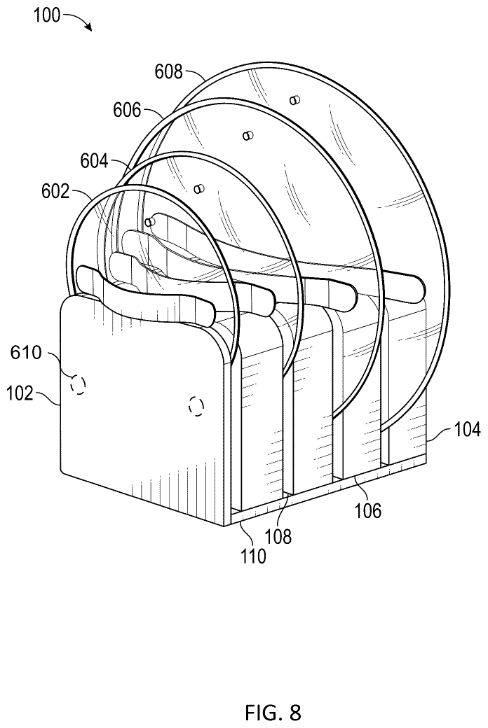

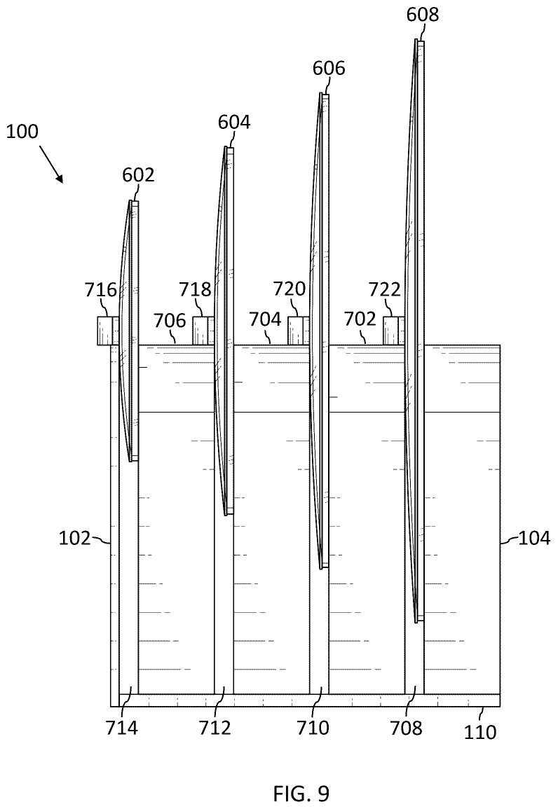

Turning to FIGS. 8 and 9, as mentioned above, the storage system 100 is further comprised of one or more lids comprising the small lid 602, the first intermediate lid 604, the second intermediate lid 606, and the large lid 608. In an embodiment, the small lid 602 may be housed by the fourth storage slot 714, the first intermediate lid 604 may be housed by the third storage slot 712, the second intermediate lid 606 may be housed by the second storage slot 710, and the large lid 608 may be housed by the first storage slot 708. However, any one of the one or more lids may be housed within any one of the first storage slot 708, second storage slot 710, third storage slot 712, and fourth storage slot 714. In another embodiment, the plurality of magnets 610 may reversibly adhere to the one or more lids.

Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

Various elements, which are described herein in the context of one or more embodiments, may be provided separately or in any suitable subcombination. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

All references, patents and patent applications and publications that are cited or referred to in this application are incorporated in their entirety herein by reference. Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A culinary equipment storage system comprising:
a modular storage apparatus comprising:
a bottom surface;
a front end disposed orthogonally to the bottom surface,
the front end having a front end width;
a back end disposed orthogonally to the bottom surface,
the back end having a back end width;
a plurality of dividers disposed orthogonally to the bottom surface between the front end and the back end,
each of the plurality of dividers having a divider width; and
a plurality of storage slots disposed between the front end, the plurality of dividers, and the back end, and
the front end, the back end, and the plurality of dividers extending vertically from the bottom surface,
wherein the front end, the back end, and the plurality of dividers are parallel to one another.

2. The culinary equipment storage system of claim 1, wherein the back end width is equal to the divider width, and wherein the back end width and the divider width are each greater than the front end width.

3. The culinary equipment storage system of claim 1, wherein the plurality of dividers are comprised of a first divider, a second divider, and a third divider.

4. The culinary equipment storage system of claim 3, wherein the plurality of storage slots are comprised of:
a first storage slot between the back end and the first divider;
a second storage slot between the first divider and the second divider;
a third storage slot between the second divider and the third divider; and
a fourth storage slot between the third divider and the front end.

5. The culinary equipment storage system of claim 4, wherein the modular storage apparatus further comprises:
a plurality of magnets disposed within at least one of the:
front end,
back end,
first divider,
second divider, and
third divider.

6. The culinary equipment storage system of claim 5, further comprising:
one or more lids comprising:
a small lid;
a first intermediate lid;
a second intermediate lid; and
a large lid.

7. The culinary equipment storage system of claim 6, wherein the plurality of magnets reversibly adhere to the one or more lids.

8. The culinary equipment storage system of claim 6, wherein:
the small lid is housed by the fourth storage slot,
the first intermediate lid housed by the third storage slot,
the second intermediate lid is housed by the second storage slot, and
the large lid is housed by the first storage slot.

9. The culinary equipment storage system of claim 6, wherein the one or more lids further comprise:
a small handle disposed atop the small lid;
a first intermediate handle disposed atop the first intermediate lid;
a second intermediate handle disposed atop the second intermediate lid; and
a large handle disposed atop the large lid.

10. The culinary equipment storage system of claim 9, wherein the plurality of magnets are disposed within a top surface of at least one of the back end, the first divider, the second divider, and the third divider.

11. The culinary equipment storage system of claim 10, wherein the small handle, first intermediate handle, second intermediate handle, and large handle reversibly adhere to the plurality of magnets disposed within the top surface of the front end, third divider, second divider, and first divider, respectively.

12. A culinary equipment storage system comprising:
a modular storage apparatus comprising:
a bottom surface;
a front end disposed orthogonally to the bottom surface,
the front end having a front end width;
a back end disposed orthogonally to the bottom surface,
the back end having a back end width;
a plurality of dividers disposed orthogonally to the bottom surface between the front end and the back end, the plurality of dividers comprising:
a first divider,
a second divider, and
a third divider;
the plurality of dividers having a divider width;
a plurality of storage slots disposed between the front end, the plurality of dividers, and the back end, the plurality of storage slots comprising:
a first storage slot between the back end and the first divider,
a second storage slot between the first divider and the second divider,
a third storage slot between the second divider and the third divider, and
a fourth storage slot between the third divider and the front end; and
the front end, the back end, and the plurality of dividers extending vertically from the bottom surface,
wherein the front end, the back end, and the plurality of dividers are parallel to one another.

13. The culinary equipment storage system of claim 12, wherein the modular storage apparatus further comprises:
a plurality of magnets disposed within at least one of the:
front end,
back end,
first divider,
second divider, and
third divider.

14. The culinary equipment storage system of claim 13, further comprising:
one or more lids comprising:
a small lid having a small handle;
a first intermediate lid having a first intermediate handle;
a second intermediate lid having a second intermediate handle; and
a large lid having a large handle.

15. The culinary equipment storage system of claim 14, wherein the plurality of magnets are disposed within a top surface of at least one of the back end, the first divider, the second divider, and the third divider.

16. The culinary equipment storage system of claim 15, wherein the small handle, first intermediate handle, second intermediate handle, and large handle reversibly adhere to the plurality of magnets disposed within the top surface of the front end, third divider, second divider, and first divider, respectively.

17. The culinary equipment storage system of claim 1, the modular storage apparatus further comprising a left side, a right side, and a top side, wherein each of the plurality of storage slots is at least partially open to an environment along the left side and the right side, and wherein each of the plurality of storage slots is fully open along the top side.

18. The culinary equipment storage system of claim 12, the modular storage apparatus further comprising a left side, a right side, and a top side, wherein each of the plurality of storage slots is at least partially open to an environment along the left side and the right side, and wherein each of the plurality of storage slots is fully open along the top side.

19. The culinary equipment storage system of claim 17, wherein each of the plurality of storage slots is partially defined by a flat portion of the bottom surface.

20. The culinary equipment storage system of claim 1 wherein each of the plurality of storage slots is partially defined by a flat portion of the bottom surface.
